(19) United States
(12) Patent Application Publication
(10) Pub. No.: US 2024/0343159 A1
(43) Pub. Date: Oct. 17, 2024

(54) POWER MANAGEMENT SYSTEM FOR A BATTERY-OPERATED VEHICLE AND A METHOD OF OPERATING THE SAME

(71) Applicant: MAGNOLIA GROUP, LLC, Covington, LA (US)

(72) Inventor: Mark Adam Miller, Covington, LA (US)

(21) Appl. No.: 18/751,890

(22) Filed: Jun. 24, 2024

Related U.S. Application Data
(63) Continuation-in-part of application No. 18/230,132, filed on Aug. 3, 2023.
Application No. 18/230,132 is a continuation of application No. 17/515,900, filed on Nov. 1, 2021, now abandoned.
(60) Provisional application No. 63/196,740, filed on Jun. 4, 2021.

(51) Int. Cl. B60L 58/18; B60L 58/12; B60W 10/26; H02J 7/14

(52) U.S. Cl. CPC B60L 58/18; B60L 58/12; B60W 10/26; H02J 7/14; B60W 2510/244

(57) ABSTRACT

Power management system for battery-operated vehicle including electric motor, and kinetic energy devices for capturing kinetic friction energy produced by moving parts in the vehicle. A central direct current (DC) supercharge component (CDCSC) converts kinetic friction energy into an electric current. The CDCSC connects to a current toggle that directs electric current to battery packs i.e., a first battery pack and second battery pack for powering the electric motor. The current toggle directs electric current to battery packs to recharge/store power. The power management system governs power output from the battery packs, manages depletion/efficiency of the battery packs. The power management system includes a parallel port that directs outgoing power feeds from the battery packs to the electric motor. The electric motor connects to a drive shaft of the vehicle. The power management system includes an additional battery pack that stores excess kinetic friction energy captured for external transfer.

### CROSS-REFERENCE TO RELATED APPLICATIONS

The present application is a continuation-in-part of U.S. patent application Ser. No. 18/230,132, filed Aug. 3, 2023; which is a continuation of U.S. patent application Ser. No. 17/515,900, filed Nov. 1, 2021 (now abandoned); which claims benefit of Provisional Application No. 63/196,740, filed Jun. 4, 2021; all of which are incorporated herein in their entirety and referenced thereto.

### BACKGROUND OF THE INVENTION

### Field of the Invention

The present invention relates to a power management system for a battery-operated vehicle. More specifically, the present subject matter relates to a power generation, recharge and management system that provides an uninterrupted power supply loop for operating a battery-operated vehicle for a longer time and distance without the need for external plug-in recharging needs.

### Description of the Prior Art

It is known that an electric vehicle (or EV vehicle), also referred as a battery-operated vehicle, uses one or more electric motors for propulsion of the vehicle. The electric motors are generally powered by rechargeable batteries on-board the vehicle. Typically, a driver of the electric vehicle recharges the batteries of the vehicle by connecting the vehicle to a charging station that transfers electric energy to the vehicle. The distance the electric vehicle can be driven on a single charge depends on type of batteries used, the weight of the vehicle, among other things.

Some electric vehicles have a limited range and only be driven a limited distance (e.g., between 100 to 250 miles) due to the low amount of energy that can be stored in the rechargeable batteries. Once the batteries are discharged, they must be recharged before the electric vehicle can be used again. Typically, it takes considerable time e.g., up to 3 to 6 hours to charge the battery, which depends on the type of batteries.

Several techniques have been disclosed in the past to charge the batteries of an electric vehicle. One such example is disclosed in a U.S. Pat. No. 7,602,140, entitled, “Apparatus for supplying power for a vehicle” (“the '140 patent”). The '140 patent discloses an apparatus for supplying power for a vehicle includes a first battery, a second battery, a switching device, a monitoring device and a control device. The first battery is electrically connected to load devices which are mounted on the vehicle. The second battery serves as a backup power source. The switching device switches the first and second batteries. The monitoring device monitors remaining capacity for each of the first and second batteries. When the control device determines that the remaining capacity of the second battery is less than the remaining capacity of the first battery based on information monitored by the monitoring device, the control device controls the switching device so as to conduct switching of the first and second batteries.

Another example is disclosed in a U.S. Pat. No. 8,639,406, entitled “Switch controlled battery charging and powering system for electric vehicles” (“the '406 patent”). The '406 patent provides methods and apparatuses for operating an electric vehicle using switch-controlled battery charging and powering systems. The apparatuses and methods disclosed herein include a first and second battery pack that are alternatively recharged multiple times and alternatively power the electric motor using a first and second switch. In some implementations, the battery packs are charged using a generator operatively connected to a wheel axle or the shaft of the vehicle's motor.

Another example is disclosed in a PCT Publication No. 2016081988, entitled “Power management for an electric vehicle” (“the '988 Publication”). The '988 Publication discloses a power system for an electric vehicle. An electric motor is arranged to provide driving mechanical output for moving the vehicle. An electric generator is arranged to convert mechanical energy, due to movement of the vehicle, into electrical energy. The system includes a first and a second rechargeable electrical power storage device, which are electrically isolated from one another. A controller is arranged to selectively connect one of the first and second rechargeable electrical power storage device with the electric motor in order to power the motor, and selectively connect the other of the first and second electrical power storage device with the generator to receive charging.

Another example is disclosed in a U.S. Pat. No. 9,610,848, entitled “On-board charging system and control method thereof” (“the '848 patent”). The '848 patent discloses an on-board charging system in which a main battery is charged with generated power by a solar cell after the generated power is stepped up in a voltage by a step-up converter includes a step-up ratio calculating portion configured to calculate a step-up ratio when stepping up the voltage with the step-up converter. The auxiliary battery is set as a charging target battery if it is determined that the calculated step-up ratio is equal to or greater than the determination threshold value, and the main battery is set as the charging target battery if it is not determined that the calculated step-up ratio is equal to or greater than the determination threshold value.

Another example is disclosed in a U.S. Pat. No. 7,486,034, entitled “Power supply device for vehicle and method of controlling the same” (“the '034 patent”). The '034 patent discloses a power supply device for a vehicle includes a battery serving as a first electric storage device, a battery serving as a second electric storage device, a motor generator driving a wheel, a selection switch selecting one of the first and second electric storage devices and connecting the selected electric storage device to the motor generator, and a control device controlling switching of the selection switch in accordance with a state of charge of each of the first and second electric storage devices. In the case where the selection switch selects the first electric storage device, when charging is performed and the state of charge of the first electric storage device becomes higher than a first prescribed level, the control device instructs the selection switch to select the second electric storage device.

Although the above-discussed disclosures provide power supply systems for operating the electric vehicle, they have several problems. For example, the electric vehicles have the problem of range uncertainty or range limitation. As such, in particular given real ranges below 250 miles, meaningful long-distance operation is not possible as they still require repeated recharging.

Therefore, there is a need for a power management system that provides an uninterrupted power supply loop for operating a battery-operated vehicle or an electric vehicle for a longer time and distance without the need for external plug-in recharging needs.

### SUMMARY OF THE INVENTION

It is an object of the present invention to provide a power management system that provides an uninterrupted power supply loop for operating a battery-operated vehicle or an electric vehicle for a longer time and distance without the need for external plug-in recharging needs and that avoids the drawback of known techniques.

It is another object of the present subject matter to provide a power management system for electric vehicles (EVs), capable of delivering a constant, renewable, uninterrupted power supply, and an increase by an order of magnitude (10× plus) in both operational range and operational time to EVs and similar mechanically powered machinery and industrial systems, without the need for external plug-in recharging needs.

It is another object of the present subject matter to provide a power management system that operates as a power generation and management system and provides an uninterrupted power supply loop to operate a battery-operated vehicle for longer duration of time and/or distance.

It is another object of the present subject matter to provide a power management system that uses less energy, and delivers more efficient operational function.

In order to achieve one or more objects, the present subject matter provides a power management system for a battery-operated vehicle (or simply vehicle). The power management system includes an electric motor. The electric motor connects to a drive shaft of the vehicle. The vehicle moves resulting in movement of moving parts in the vehicle. The moving parts include, but not limited to, an axle, a drive shaft, wheels, braking, sensors, axle friction recharge, wheel rotation friction recharge, brake pad friction, exterior vehicle/mechanism friction capture, wind/water (hull friction, wake, etc.), and solar surface on vehicle, etc. The power management system includes kinetic energy devices that connect on, near, and/or around the moving parts of the vehicle. The kinetic energy devices capture kinetic friction energy produced by the moving parts. A central direct current (DC) supercharge component (CDCSC) converts the kinetic friction energy into an electric current (DC electric current). The CDCSC connects to a current toggle that directs the electric current to two distinct and identical battery packs i.e., a first battery pack and a second battery pack that power the electric motor. Here, whichever battery that actively powers the electric motor at any given point of time in operation is referred as a primary battery power source (or primary battery source) and the other battery is referred as a secondary battery power source (which then becomes the primary battery source when the charge in other battery pack depletes). The current toggle engages the battery packs i.e., the primary battery source providing power to the electric motor, and the secondary battery source which is recharged constantly by the return flow of kinetic energy created by the primary battery operation. The primary battery powers the electric motor, which in turn creates distinct kinetic friction energy through the movement of moving parts. These moving parts are encased or in contact with the kinetic capture devices.

When the primary battery source reaches a predefined depletion point (predefined threshold level) and requires recharging, the current toggle switches/swaps functions of the distinct battery packs, routing the electric flow to recharge the primary battery source, and enables the second battery pack to become the primary battery source to the electric motor. Each of the first battery pack and the second battery packs includes a distinct power output flow governor and flow routing hardware and software, maximizing the operational efficiency of the charge, recharge and store mechanism. This constant power, constant kinetic capture, constant DC supercharge and recharge loop enables to conserve energy.

As an added power efficiency value, if the secondary battery source (in charging position) attains full charge from the kinetic charge devices feed while the primary battery source is still operational and not depleted, then the residual electric charge generated from the kinetic charge devices (charge that is not immediately needed for recharge of the secondary battery source, referred to as the “overflow charge” or “rollover charge”), is directed to a third distinct module, i.e., a third battery pack. The third battery pack is a distinct power collection hardware source or battery pack that accepts and stores the overflow charge, allowing transfer of stored electric charge to the third battery pack when the vehicle or power management system is not in use. The third battery pack is unique further in its design as to be removable from the platform operating system. Further, the third battery has the ability to be used (after removal) as a standalone battery power bank energy source for external needs. The third battery source is removable and replaceable via connection through a battery port identical to the first battery and second battery ports which allow the receiving source power from the platform. Securing mechanisms onboard ensure the third battery is immovable onboard under active vehicle operating conditions.

In addition, each of the first battery pack, the second battery pack and the third battery pack may include, as an alternate option to the use of a current market third party battery, a graphene sphere-based battery (GSB). The GSB encompasses a spherical battery shell, or a cylindrical or rectangular elongated shell casing with similar internal graphene sheet designs with concentric circles of thin graphene sheet material attached to internal anchoring posts holding the graphene material in place. The GSB includes a thermophotovoltaic (TPV) sensor casing surrounding a battery casing. The battery casing includes graphene sheets attached using attachment posts to retain them in shape. The TPV sensor casing includes battery ports for supplying power to the electric motor. In one embodiment, the GSB includes an anode(s) and/or cathode(s) on, around, or about the graphene battery. The anode and/or cathode is constructed or manufactured of, or based in the element graphene, such that the anode(s) and/or the cathode(s) is comprised completely or partially of graphene, or includes a layering or covering of graphene, or utilizes a filtering, flow through, and/or contact point with or chemical reaction chain engaging with graphene. Here, the graphene anode(s) and/or cathode(s) is included in the power management system in combination with, or distinctly separate from the GSB as its primary or otherwise integrated/utilized source, which is not disclosed in prior art.

In one advantageous feature of the present subject matter, the power management system governs power output from batteries, manages battery/source depletion and efficiency. The power management system presents a parallel port that connects to the battery packs. The parallel port directs primary of multiple outgoing power feeds from battery packs to the electric motor.

In one advantageous feature of the present subject matter, the power management system eliminates the need for multiple generators, multiple transformers, and multiple motors. Further, the power management system stores excess kinetic energy captured in a distinct battery source (third battery pack) for external transfer/use. As specified above, the third battery pack is removable. In addition, the power management system allows for multiple additional sensors capture components to deliver charge to the battery packs.

In addition, under normal operating conditions, the presently disclosed power management system allows the battery-powered electric vehicle to have nearly unlimited range of travel (distance)—without interruption, or need for time consuming stops for “plugging i” for recharging.

Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

FIG. 1 illustrates an environment in which a power management system implements in a vehicle, in accordance with one embodiment of the present invention.

FIGS. 2 to 4 show one or more kinetic capture devices connecting over the length of axle and/or drive shaft, in accordance with exemplary embodiments of the present invention.

FIG. 5 illustrates a block diagram of power management system.

FIGS. 6A and 6B illustrate a perspective view and a top view of a battery, respectively, in accordance with one embodiment of the invention.

FIG. 7 illustrates a top view of battery, in accordance with another embodiment of the invention.

FIG. 8 illustrates the operation of the power management system, in accordance with one embodiment of the invention.

FIG. 9 illustrates a battery in a square or rectangular configuration, in accordance with one embodiment of the invention.

FIG. 10 through FIG. 12 illustrate the battery positioned at various places in a vehicle, in accordance with exemplary embodiments of the invention.

FIGS. 13A and 13B illustrate a perspective view and a top/end view of a battery, respectively of a battery, in accordance with one embodiment of the invention.

FIG. 13C illustrates another end view of the battery, in accordance with another embodiment of the invention.

FIGS. 14A and 14B illustrate a perspective view and a top/end view of a battery, respectively, of a battery, in accordance with one embodiment of the invention.

FIG. 14C illustrates another end view of the battery, in accordance with another embodiment of the invention.

It will be noted that throughout the appended drawings, like features are identified by like reference numerals.

### DETAILED DESCRIPTION OF THE PREFERRED EMBODIMENT

Before the present features and working principle of a power management system for a battery-operated vehicle is described, it is to be understood that this subject matter is not limited to the particular system as described, since it may vary within the specification indicated. Various features of a power management system for a battery-operated vehicle might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

It should be understood that the present subject matter describes a power management system for battery-operated vehicle. The power management system includes an electric motor. The electric motor connects to a drive shaft of the vehicle. The vehicle moves resulting in movement of moving parts in the vehicle. The power management system includes kinetic energy devices for capturing kinetic friction energy produced by the moving parts. A central direct current (DC) supercharge component (CDCSC) converts the kinetic friction energy into an electric current. The CDCSC connects to a current toggle that directs the electric current to battery packs i.e., a first battery pack and a second battery pack for powering the electric motor. The current toggle directs the electric current to the battery packs to recharge or store power. The power management system governs power output from the battery packs, manages depletion and efficiency of the battery packs. The power management system includes a parallel port that directs outgoing power feeds from the battery packs to the electric motor. The electric motor connects to a drive shaft of the vehicle. The power management system includes an additional battery pack that stores excess kinetic friction energy captured for external transfer.

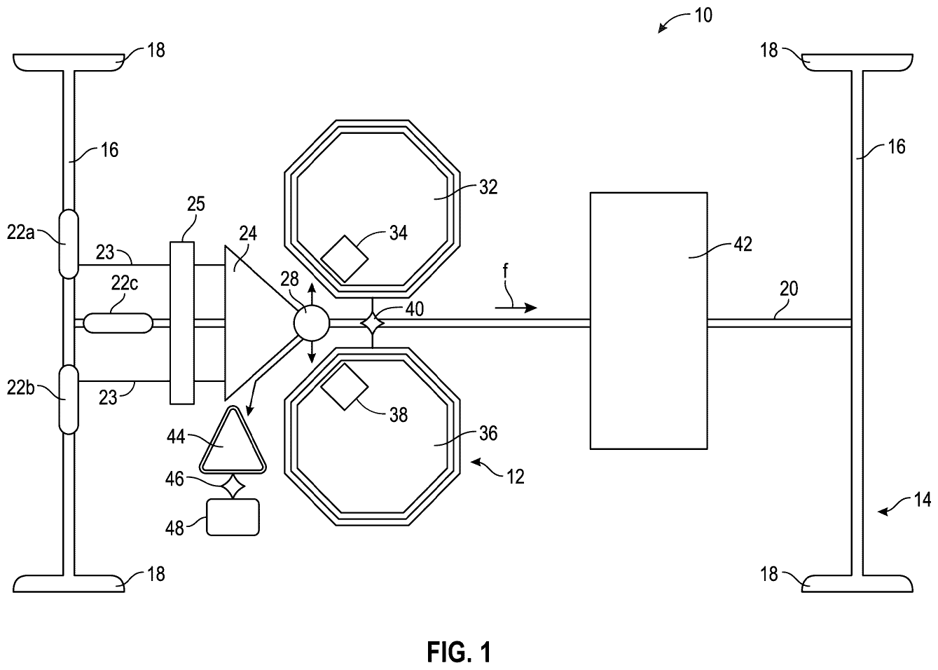

Various features and embodiments of the power management system for a battery-operated vehicle are explained in conjunction with the description of FIGS. 1-12.

The present subject matter discloses a power management system for a battery-operated vehicle. FIG. 1 shows environment 10 in which power management system 12 implements in vehicle 14, in accordance with one embodiment of the present subject matter. The term “vehicle” as used herein refers to either an all-electric vehicle, also referred to as an EV, or a battery-operated vehicle, plug-in hybrid vehicles, also referred to as a PHEV, or a hybrid vehicle (HEV), a hybrid vehicle utilizing multiple propulsion sources one of which is an electric drive system. Here, vehicle 14 includes a motor cycle, car, truck, boat, train or any other vehicle that operates on energy stored in a battery.

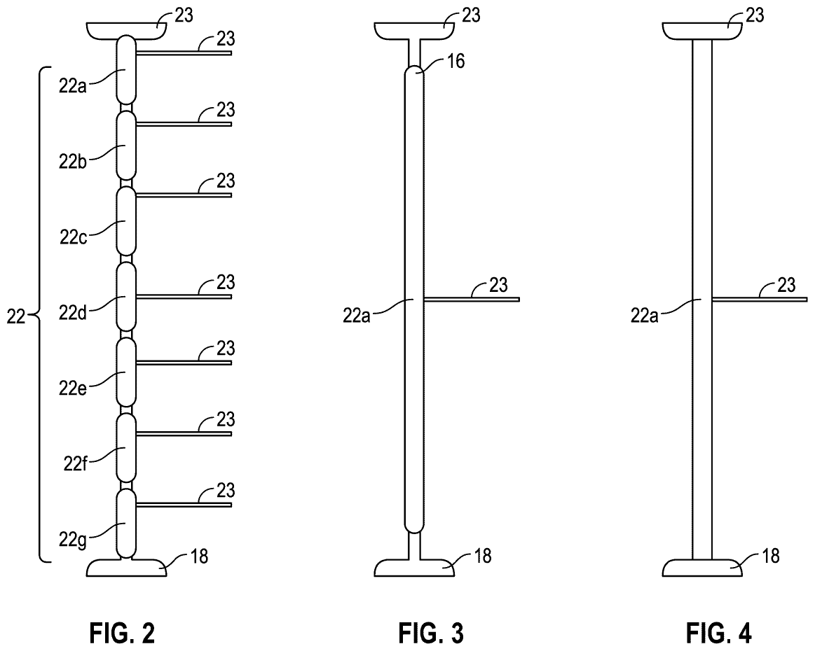

The present description is explained considering that vehicle 14 is a car. However, a person skilled in the art understands other vehicles 12 as presented above may also implement the presently disclosed power management system 12 for operating vehicle 14. Vehicle 14 encompasses axle 16 connecting wheels 18, say at the front and rear of vehicle 14. Axle 16 connects to drive shaft or power train 20 that controls movement of vehicle 14. In accordance with one embodiment of the present subject matter, power management system 12 includes one or more kinetic capture devices such as first kinetic capture device 22 a, second kinetic capture device 22 b and third kinetic capture device 22 c, collectively referred as kinetic capture devices 22. FIG. 1 shows first kinetic capture device 22 a and second kinetic capture device 22 b connecting to axle 16, and third kinetic capture device 22 c to drive shaft 20. However, a person skilled in the art understands kinetic capture devices 22 connect in any number depending on the moving parts present in vehicle 14. A person skilled in the art understands FIG. 2 illustrates axle 16 containing multiple smaller kinetic capture devices 22 of smaller configuration. Further, FIGS. 3 and 4 illustrate a single elongated kinetic capture device 22 that extends substantial or entire length of axle 16. FIGS. 2, 3 and 4 show one or more kinetic capture devices 22 connect over the length of axle 16. A person skilled in the art understands that one or more kinetic capture devices 22 connect over the length of drive shaft 20 without departing from the scope of the present subject matter.

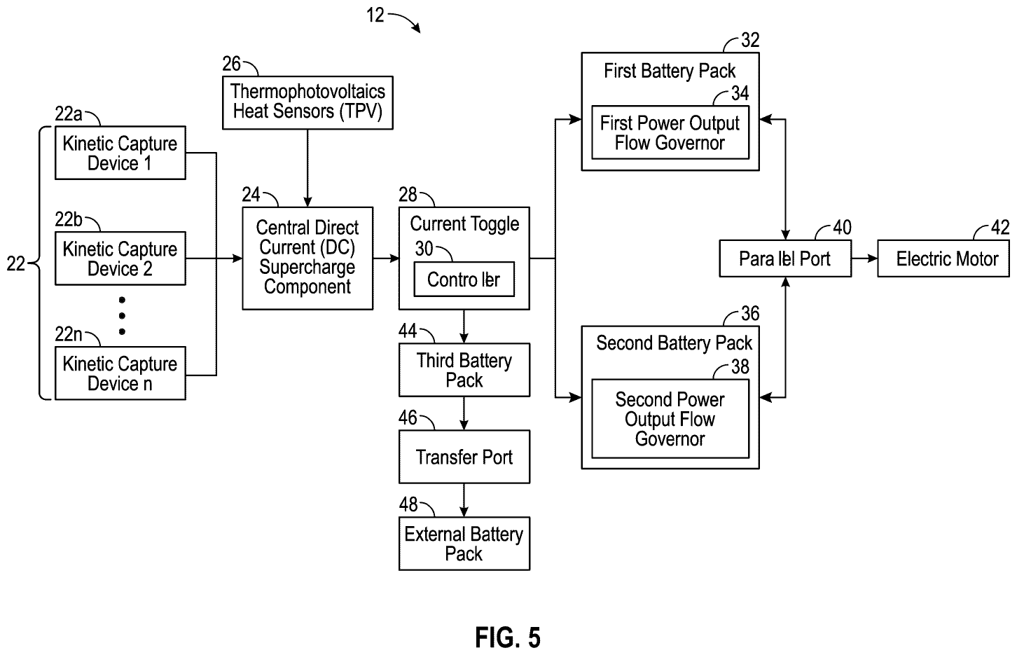

Now referring to FIGS. 1 and 5, working of power management system 12 in vehicle 14 is explained. As specified above, FIG. 1 show environment 10 in which power management system 12 implements in vehicle 14. FIG. 5 shows a block diagram of power management system 12, in accordance with one embodiment of the present subject matter. As specified above, power management system 12 includes kinetic capture devices 22. In one example, kinetic capture devices 22 are manufactured and configured to function using best available energy harvesting efforts and processes including, but not limited to, materials such as ceramics, ball bearings, magnets or magnetized parts, laser or light beam elements, or any other available and effective manner of energy harvesting.

Kinetic capture devices 22 connect to axle 16 and/or drive shaft 20. Kinetic capture devices 22 connect on, near, and/or around axle 16 and/or drive shalt 20 in a variety of patterns. Each of kinetic capture devices 22 captures kinetic friction energy from movement of moving parts in vehicle 14. In one example, kinetic capture devices 22 captures kinetic friction energy from axle 16, drive shaft 20, braking, sensors, axle friction recharge, wheel rotation friction recharge, brake pad friction, exterior vehicle/mechanism friction capture, wind/water (hull friction, wake, etc.), solar surface on vehicle 14, etc. Each of kinetic capture devices 22 captures the kinetic friction energy produced by movement of moving parts in vehicle 14, and transfers the kinetic friction energy via flow transfer cable(s) 23 to central direct current (DC) supercharge component 24, hereinafter referred as CDCSC 24. In one implementation, one or more kinetic capture devices 22 attach to axle 16 and/or drive shaft 20, each kinetic capture device 22 delivering a single or multiple distinct electric charge(s) to CDCSC 24 via flow transfer cable 23, as shown in FIG. 2, for example. FIG. 2 shows an exemplary embodiment in which axle 16 including seven kinetic capture devices 22 i.e., first kinetic capture device 22 a, second kinetic capture device 22 b, third kinetic capture device 22 c, fourth kinetic capture device 22 d, fifth kinetic capture device 22 e, sixth kinetic capture device 22 f and seventh kinetic capture device 22 g. A person skilled in the art understands that the number of flow transfer cables 23 used for transferring the kinetic friction energy produced by kinetic capture devices 22 to CDCSC 24 changes depending on the need and/or pattern of kinetic capture devices 22 placed over axle 16 and/or drive shaft 20.

In another implementation, axle 16 and/or drive shaft 20 surrounds or contains entirely or substantially by a single kinetic capture device 22 a. FIG. 3 shows an exemplary embodiment in which a single kinetic capture device 22 connecting along the substantial length of axle 16. Additionally, kinetic capture device 22 connect along the substantial length of drive shaft 20. Here, kinetic capture device 22 a engages axle 16 and/or drive shaft 20 directly or fully. Kinetic capture device 22 a employs a single or multiple distinct reporting and delivering electric charge(s) to CDCSC 24 via flow transfer cable 23, as shown in FIG. 3, for example.

In another implementation, axle 16 and/or drive shaft 20 come precast (manufactured together with or fully integrated) with kinetic capture device 22 a. FIG. 4 shows an exemplary embodiment in which a single kinetic capture device 22 extends over the entire length of axle 16. Optionally, kinetic capture device 22 extend over the entire length of drive shaft 20. Here, kinetic capture device 22 a engages axle 16 and/or drive shaft 20 directly and/or fully. Kinetic capture device 22 a employs a single or multiple distinct reporting and delivering electric charge(s) to CDCSC 24 via flow transfer cable 23, as shown in FIG. 4, for example.

In one example, CDCSC 24 connects to kinetic capture devices 22 a, 22 b, 22 c, via a generator device 25. Here, generator device 25 generates, or aids in the generation of, additional or supplemental electrical current that can be used specifically to recharge the onboard battery system(s)—whether single, dual or multiple battery usage is being employed in the platform and vehicle. Generator device 25 presents itself as and embodies physical operations and processes through electrical self-powering mechanism (wherein generator device 25 utilizes or supplies an electric charge to perform its internal generator operations), or present through fuel-based powered mechanism (as would current or future market available fuel-based internal combustion engine generator provides (“ICE” as noted in FIG. 1)). Examples of the fuel-based power usage include a common or complex gasoline, diesel, propane, ethanol, butane, or any other combustible agent resulting in an ICE-based generator.

Generator device 25 illustrated herein generates, or aids in the generation of, and provides electric current for specific utilization toward the recharging of the primary and additional battery(ies) on the electric motor-powered vehicle and platform system. Generator device 25 illustrated herein does not (or may not, optionally) cause the movement of the axels or other mechanical parts of the vehicle. Generator device 25 supplies electric current in order to recharge the battery(ies). Optionally, generator device 25 provides direct power flow to the electric motor itself, bypassing the remaining power management system 12, and delivering its generated charge and interacting with the electric motor directly. In turn, generator device 25 causes the electric motor to manipulate and cause the movement of the axels and other mechanical parts. In this alternate embodiment, generator device 25 operates independently of, and optionally may not receive harvested energy from, kinetic capture devices 22.

In each of the above embodiments, the process chain of the platform, the kinetic capture devices 22 have the option to bypass generator device 25 entirely, have no direct interaction with generator device 25, and direct its kinetic capture device 22 harvested current flow directly into the SuperCharge element. Further, as the generator device 25 is an optional operating platform element, it is not required for successful performance, but it is inseparably considered as an included design without departing from the present scope of the invention.

Upon receiving the kinetic friction energy captured by kinetic capture devices 22, CDCSC 24 converts the kinetic friction energy captured to a DC electric current. Subsequently, CDCSC 24 directs the DC electric current to battery packs i.e., first battery pack 32 and second battery pack 36 via current toggle 28. The DC electric current is used for charging or recharging first battery pack 32 and second battery pack 36. Current toggle 28 directs the DC electric current to traffic and provide constant recharging one of first battery pack 32 and second battery pack 36. In one example, current toggle 28 includes controller 30. Controller 30 simultaneously switches the flow of incoming DC current to one of first battery pack 32 and second battery pack 36, as it immediately begins recharging for later toggle back. Controller 30 includes a software/hardware module that stores charge levels of first battery pack 32 and second battery pack 36. Further, controller 30 maintains and records the depletion point or predefined threshold levels of charge to switch charging of first battery pack 32 and second battery pack 36 by current toggle 28. In addition, current toggle 28 directs the incoming DC electric charge to third battery back 44 when first battery pack 32 and second battery pack 36 are fully charged or when a rollover option is engaged. The rollover charge indicates a charge that is not immediately needed for recharge of the secondary battery source. In other words, when the secondary battery source (in charging position) attains full charge from the kinetic charge devices feed while the primary battery source is still operational and not depleted, then the residual electric charge generated from the kinetic charge devices is referred as overflow charge” or “rollover charge”. In one implementation, current toggle 28 monitors charge, output levels, switchover needs of first battery pack 32 and second battery pack 36 and functional reports of axle 16 and drive shaft 20.

In one implementation, CDCSC 24 connects to Thermophotovoltaics (TPV) heat sensors 26. TPV heat sensors 26 includes one or more heat management and transference sensors that surround battery packs i.e., first battery pack 32 and second battery pack 36. TPV heat sensors 26 act as heat contact sensors. TPV heat sensors 26 capture the heat produced from first battery pack 32 and second battery pack 36 and create a distinct DC electric current (current charge). The distinct DC electric current is then directed to and fed into CDCSC 24 (FIG. 5). In accordance with one embodiment of the present subject matter, TPV heat sensors 26 provide additional sourcing of electric current generated (in addition to kinetic friction energy created by kinetic capture devices 22) in power management system 12. As such, TPV heat sensors 26 serve as an additional recharge power and heat management system for battery packs i.e., first battery pack 32 and second battery pack 36.

In another implementation, CDCSC 24 connects to additional sensors. Additional sensors, include, but not limited to, including solar, wind flow drag over vehicle surfaces, water flow (hydro drag) over hull, compression, additional friction, etc.

As can be seen from FIGS. 1 and 5, current toggle 28 connects to battery packs i.e., first battery pack 32 and second battery pack 36 to direct and control the flow of DC electric current for charging them. First battery pack 32 and second battery pack 36 are identical but distinct battery packs. The term “battery pack” as used herein refers to multiple individual batteries contained within a single piece or multi-piece housing, the individual batteries electrically interconnected to achieve the desired voltage and capacity for a particular application. The terms, “battery”, “cell”, and “battery cell” may be used interchangeably and may refer to any of a variety of different cell types, chemistries and configurations including, but not limited to, lithium ion (e.g., lithium iron phosphate, lithium cobalt oxide, other lithium metal oxides, etc.), lithium ion polymer, nickel metal hydride, nickel cadmium, nickel hydrogen, lithium-nickel-cobalt-aluminum, lithium-nickel-manganese-cobalt, nickel zinc, silver zinc, or other battery type/configuration.

Here, each of first battery pack 32 and second battery pack 36 includes a non-metal-air battery pack or metal-air battery pack, depending on the need. Given the high energy density and the large capacity-to-weight ratio offered by metal-air cells, they are well suited for use in vehicle 14. Due to their limited power density, however, their use is most appropriate when combined with a more conventional power source, such as a lithium-ion battery pack. As used herein, metal-air batteries refer to any cell that utilizes oxygen as one of the electrodes and metal (e.g., zinc, aluminum, magnesium, iron, lithium, vanadium, etc.) in the construction of the other electrode. Battery pack that utilizes non-metal-air cells provide high power density, thus providing a combined power source that achieves an optimal combination of energy and power. Exemplary batteries that use non-metal-air cells include, but are not limited to, lithium ion (e.g., lithium iron phosphate, lithium cobalt oxide, other lithium metal oxides, etc.), lithium-ion polymer, nickel metal hydride, nickel cadmium, nickel hydrogen, nickel zinc, silver zinc, etc.

First battery pack 32 includes first power output flow governor 34. First power output flow governor 34 indicates a software and/or hardware module that installs on the output flow of first battery pack 32 and communicatively connects to current toggle 28. First power output flow governor 34 maintains a power output ceiling for first power output flow governor 34 when one of first battery pack 32 and second battery pack 36 acts as a primary battery source for providing operating power to electric motor 42. First power output flow governor 34 manages battery power to effectively reach maximum, nearly unlimited EV range and uninterrupted operational time which is critical to maximizing operational performance of power management system 12 and/or vehicle 14. First power output flow governor 34 ensures the battery power usage is sufficient to deliver the maximum power to electric motor 42 for the longest timeframe, thus enabling charging of second battery pack 36 to gain full recharge time. First power output flow governor 34 operates to ensure vehicle 14 still maintains plenty of acceleration capacity and torque to achieve normal speed and operational needs for the user of vehicle 14. In addition, first power output flow governor 34 maintains efficient power flow so as not to drain the battery power supply.

Similarly, second battery pack 36 includes second power output flow governor 38. Second power output flow governor 38 indicates a software and/or hardware module that installs on the output flow of second battery pack 36 and communicatively connects to current toggle 28. Second power output flow governor 38 maintains a power output ceiling for second power output flow governor 38 when one of first battery pack 32 and second battery pack 36 acts as a primary battery source for providing operating power to electric motor 42. Second power output flow governor 38 manages battery power to effectively reach maximum, nearly unlimited EV range and uninterrupted operational time which is critical to maximizing operational performance of power management system 12 and/or vehicle 14. Second power output flow governor 38 ensures the battery power usage is sufficient to deliver the maximum power to electric motor 42 for the longest timeframe, thus enabling charging of first battery pack 32 to gain full recharge time. Second power output flow governor 38 operates to ensure vehicle 14 still maintains plenty of acceleration capacity and torque to achieve normal speed and operational needs for the user of vehicle 14. In addition, second power output flow governor 38 maintains efficient power flow so as not to drain the battery power supply.

Each of first battery pack 32 and second battery pack 36 connects to parallel port 40 that directs/delivers the power output from one of first battery pack 32 and second battery pack 36 to electric motor 42. In accordance with the present subject matter, parallel port 40 acts as an adapter, which controls and defines current flow to electric motor 42 from one of first battery pack 32 and second battery pack 36 to power electric motor 42. In other words, parallel port 40 connects to both first battery pack 32 and second battery pack 36, and receives and directs power output from whichever battery pack is acting as a primary battery source to operate electric motor 42. Power output from one of first battery pack 32 and second battery pack 36 delivers to parallel port 40, which in turn toggles drive shaft 20, directing flow f (FIG. 1) from appropriate battery to electric motor 42.

In accordance with one embodiment of the present subject matter, the battery pack powering electric motor 42 is referred as a primary battery source and the battery that is getting recharged while the other battery pack is powering electric motor 42 is referred as a secondary battery source. In other words, current toggle 28 engages two distinct but identical battery packs first battery pack 32 and second battery pack 36. The battery pack i.e., the primary battery source (say first battery pack 32) provides power to electric motor 42, and the secondary battery source (say second battery pack 36) gets recharged constantly by the return flow of kinetic energy created by the operation (output power) of the primary battery source. The primary battery source powers electric motor 42, which in turn creates distinct kinetic friction energy through the movement of mechanical/moving parts that gets captured by kinetic capture devices 22 thereby creating a loop for operating one of the battery packs for powering electric motor 42. A person skilled in the art understands that the presently disclosed power management system utilizes the kinetic energy, which otherwise gets lost from the movement of the moving parts in vehicle 14, and converts the kinetic energy to electric current for recharging the battery packs that power electric motor 42 whenever vehicle 14 is in motion.

Assuming that first battery pack 32 is fully charged and powering electric motor 42 from the charge stored therein, then first battery pack 32 becomes the primary battery source and second battery pack 36 becomes the secondary battery source as it gets charged until power in first battery pack 32 depletes to a pre-defined threshold level. Considering the above scenario, current toggle 28 directs the DC electric current to second battery pack 36 to recharge second battery pack 36 until the charge reaches 100% in second battery pack 36 or power in first battery pack 32 reaches near or below the pre-defined threshold level. If charge in second battery pack 36 reaches 100% while first battery pack 32 (acting as primary battery source) powers electric motor 42, then second power output flow governor 38 communicates to current toggle 28 such that current toggle 28 directs the DC electric current to third battery pack 44. Further, if charge in first battery pack 32 reaches near or below the pre-defined threshold level, then second power output flow governor 38 communicates to current toggle 28 such that current toggle 28 notifies parallel port 40 to change the battery output flow from first battery pack 32 to second battery pack 36, thus making second battery pack 36 the primary battery source and allowing first battery pack 32 to get charged and act as the secondary battery source.

After notifying, parallel port 40 allows and directs power output from second battery pack 36 to electric motor 42 to operate drive shaft 20 and thereby vehicle 14. Concurrently, current toggle 28 switches (as a return flow system) the flow of the DC electric current to charge first battery pack 32. The above process repeats when first battery pack 32 charges 100% or power in second battery pack 36 reaches near or below the pre-defined threshold level. Here, the power output flow governor in respective battery pack when acting as the primary battery source maintains a power output ceiling when the battery pack is powering electric motor 42. Critical to maximizing operational performance, respective power output flow governor manages battery power to effectively reach maximum, nearly unlimited drive range for vehicle 14 and uninterrupted operational time. Assuming a driver drives vehicle 14 maximum “flat out” at top power for long period of time, current toggle 28 and power output flow governors ensure maximum efficient power outflow is appropriate, so as not to cause early depletion of the primary battery source (before secondary battery source is fully recharged). The power output flow governor of the primary battery source ensures the battery power usage is sufficient to deliver the maximum power to electric motor 42 for the longest timeframe, thus enabling charging of the secondary battery source to gain full recharge time (and net extra DC electric current sent to third battery pack 44). The power output flow governor in respective battery pack operating as the primary battery source ensures vehicle 14 maintains plenty of acceleration capacity and torque to achieve normal speed and operational needs for the user, while recharging the battery packs in loop.

In the event of the primary battery source powering electric motor 42, and the secondary battery source has been fully recharged, the rollover option or rollover charge is engaged at current toggle 28. As a full efficiency operational capture and collection of the DC electrical current, current toggle 28 directs the incoming DC electrical current to third battery back 44.

Electric motor 42 operates from the power output of one of first battery pack 32 and second battery pack 36 and drives drive shaft 20. Drive shaft 20 operates and causes movement of the moving parts in vehicle 14 such as axle 16, drive shaft 20, braking, sensors (not shown), axle friction recharge, wheel rotation friction recharge, brake pad friction, exterior vehicle/mechanism friction capture, wind/water (hull friction, wake, etc.), solar surface on vehicle 14, etc. Movement of the moving parts causes kinetic energy release, re-capture, reprocess, redirection. As explained above, kinetic capture devices 22 are configured to capture the kinetic friction energy from axle 16, drive shaft 20, braking, sensors (not shown), axle friction recharge, wheel rotation friction recharge, brake pad friction, exterior vehicle/mechanism friction capture, wind/water (hull friction, wake, etc.), solar surface on vehicle 14, etc. Kinetic capture devices 22 capture the kinetic friction energy produced by movement of moving parts in vehicle 14, and transfer the kinetic friction energy via flow transfer cable(s) 23 to CDCSC 24. This constant power, constant kinetic friction energy capture, constant DC supercharge and recharge loop ensures the energy is conserved.

Power management system 12 includes third battery pack 44, as shown in FIGS. 1 and 5. Similar to first battery pack 32 and second battery pack 36, third battery pack 44 refers to multiple individual batteries contained within a single piece or multi-piece housing, the individual batteries electrically interconnected to achieve the desired voltage and capacity for a particular application. Third battery pack 44 acts as a distinct power collection hardware source or battery pack that accepts and stores the rollover charge or overflow charge, allowing transfer of stored electric charge to third battery pack 44 when vehicle 14 or power management system 12 is not in use. When first battery pack 32 powers electric motor 42 and second battery pack 36 has been fully charged and during all excess time beyond that moment (of no recharge need for second battery pack 36), and up to the defined depletion point (predefined threshold level) of first battery pack 32; then current toggle 28 rollovers the DC electric current (converted from the kinetic friction energy captured by kinetic capture devices 22) to third battery pack 44. Similarly, when second battery pack 36 powers electric motor 42 and first battery pack 32 has been fully charged and during all excess time beyond that moment (of no recharge need for first battery pack 32), and up to the defined depletion point of second battery pack 36; current toggle 28 rollovers the DC electric current (converted from the kinetic friction energy captured by kinetic capture devices 22) to third battery pack 44. Current toggle 28 directs the incoming DC electric current to third battery pack 44 to efficiently utilize the kinetic friction energy captured by kinetic capture devices 22.

In the present subject matter, third battery pack 44 collects and stores excess and unassigned DC electric current. In other words, third battery pack 44 fills to partial or full capacity (depending on operation time). Subsequently, third battery pack 44 transfers stored power to external battery pack 48 via transfer port 46. In one example, external battery pack 48 indicates a stand-alone home/industrial/grid battery power system that the user uses to power home appliances and other power equipment from the battery power stored therein. Transfer port 46 includes a universal connection adaptability that allows a “bidirectional” charging platform. Operationally, transfer port 46 receives excess charge or outputs charge and manages outbound transfer to external battery pack 48. In the event of both first battery pack 32 and second battery pack 36 deplete (due to possible system change or failure), third battery pack 44 can be used to power electric motor 42. Here, the battery charge from third battery pack 44 is directed to flow (via current toggle 28 and attending sensors) to parallel port 40 and thus directed to power electric motor 42 (from its internal stored electrical charge, if any).

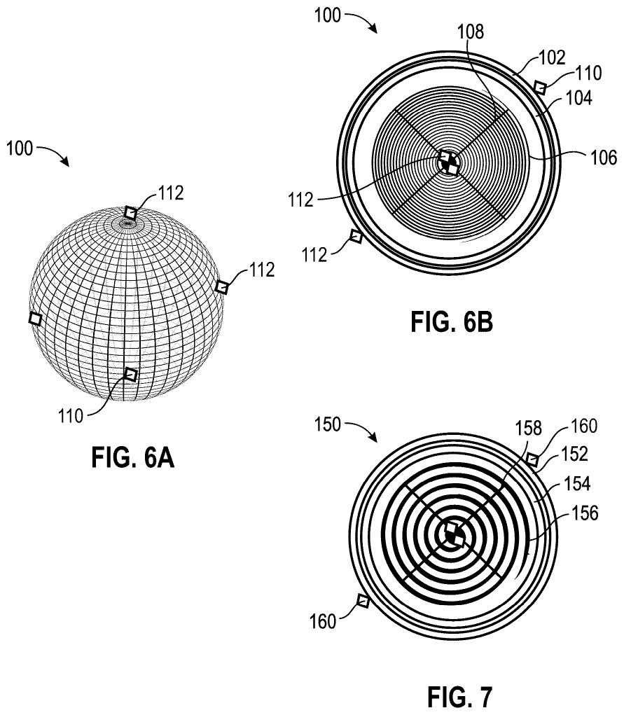

FIGS. 6A and 6B show a perspective view and a top view, respectively of graphene sphere battery (GSB) or simply battery 100, in accordance with one embodiment of present subject matter. Each of first battery pack 32, second battery pack 36 and third battery pack 44 incorporates the design of battery 100. In one implementation, battery 100 has a unique concentric layered design e.g., sphere-shaped standalone structure. Battery 100 includes a spherical battery shell with concentric circles of ultrathin graphene sheet material attached to internal anchoring posts which hold the graphene material in place. As can be seen from FIG. 6B, battery 100 has thermophotovoltaic (TPV) sensor casing 102 that surrounds battery casing 104. Battery casing 104 includes multiple graphene sheets 106. Graphene sheets 106 are attached with the help of attachment posts 108 to retain them in shape. At the outer side, TPV sensor casing 102 includes battery ports 110 that supplies power to electric motor 42. Here, water or other superconducting fluid flows around and in between all independent or conjoined graphene sheets 106.

Battery 100 operates on a principle that the more conductive and reactive surface area that interacts with the reacting and catalyst fluid, the more maximized the resulting charge. When compared to existing lithium-ion battery packs having a large pile of batteries taped or combined in a casing shell together, the presently disclosed battery 100 provides much more efficiency in increased charge and output potential, and significantly reduced gross weight and size of the on-board battery packages. As shown in FIGS. 6A and 6B, internal structure layout of graphene sheets 106 include alternately or independently concentric circles or spheres of independent graphene sheets 106 small to large in scope from the center at the battery anchor post to the outer battery casing 104. Alternatively, graphene sheets 106 include one extended, unbroken, expanding and encircling itself in a pinwheel formation from the center at the battery anchor post to the outer battery casing anchors, filling the battery casing as shown in FIG. 7 (another embodiment). The battery ports 110 maintain the integrity structure of spherical battery casing 104 and provide anchoring for graphene sheets 106. Battery port 110 includes a parallel port or separate ports (one for inflow, and another for outflow). Battery 100 optimizes inflow of recharge to the “secondary battery” position (second battery pack 36), and outflow of power capability for the “primary battery” (first battery pack 32). The super conducting capabilities of graphene sheets 106 and reactive fluid is superior to existing lithium-ion battery packs.

In one implementation, battery ports 110 receive an anode(s) and/or cathode(s) 112. Anode(s) and/or cathode(s) 112 position on, around, or about battery 100, as can be seen from FIGS. 6A and 6B. In one example, anode and/or cathode 112 is constructed or manufactured of, or based in the element graphene, such that anode(s) and/or the cathode(s) 112 is comprised completely or partially of graphene, or includes a layering or covering of graphene, or utilizes a filtering, flow through, and/or contact point with or chemical reaction chain engaging with graphene. Optionally, anode(s) and/or the cathode(s) 112 is positioned separately from battery 100.

FIG. 7 shows a top view of battery 150, in accordance with another embodiment of present subject matter. In the current embodiment, battery 150 includes a continuous or expanding “pinwheel structure”. Similar to battery 100, battery 150 has thermophotovoltaic (TPV) sensor casing 152 that surrounds battery casing 154. Battery casing 154 includes multiple graphene sheets 156. Graphene sheets 156 are attached with the help of attachment posts 158 to retain them in shape. At the outer side, TPV sensor casing 152 includes battery ports 110 that supplies power to electric motor 42. Here, water or other superconducting fluid flows around and in between all independent or conjoined graphene sheets 156. In one example, attachment posts 158 include anode(s) and/or the cathode(s) 160. Anode(s) and/or the cathode(s) 160 position in combination with, or distinctly separate from battery 150, similarly to anode(s) and/or the cathode(s) 112 positioned in or around battery 100, as explained above. In the present embodiment, the inclusion of anode(s) and/or the cathode(s) 160 in combination with, or distinctly separate from, battery 100 as its primary or otherwise integrated/utilized source is distinct, which is not disclosed in prior art.

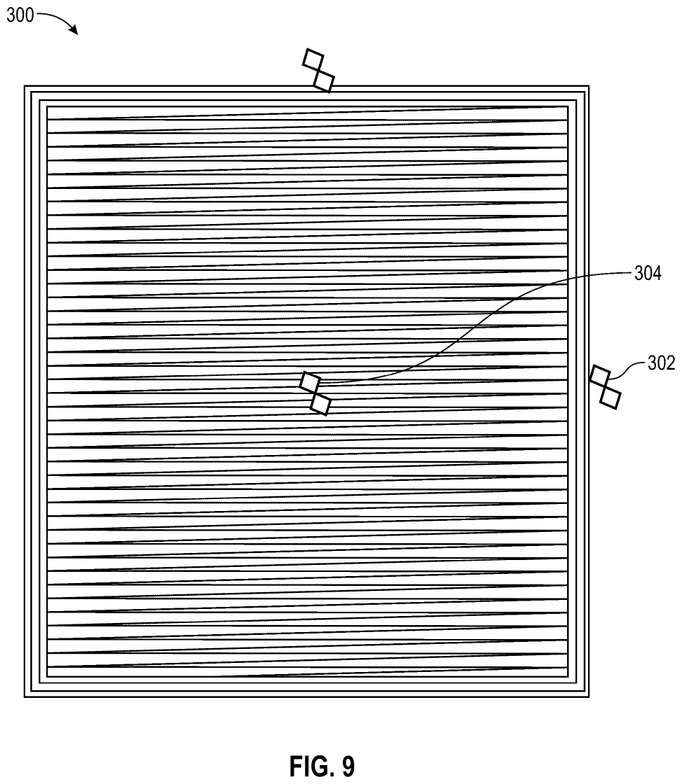

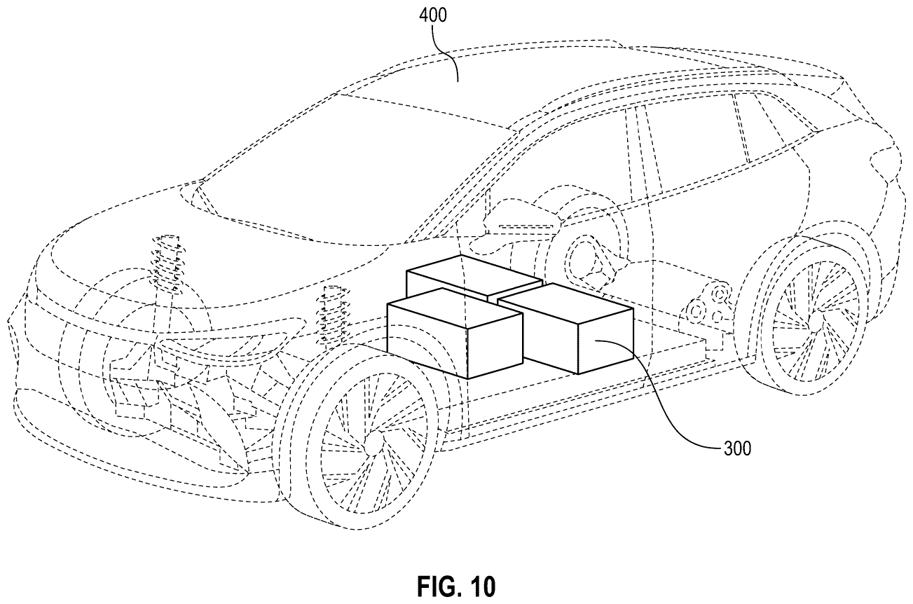

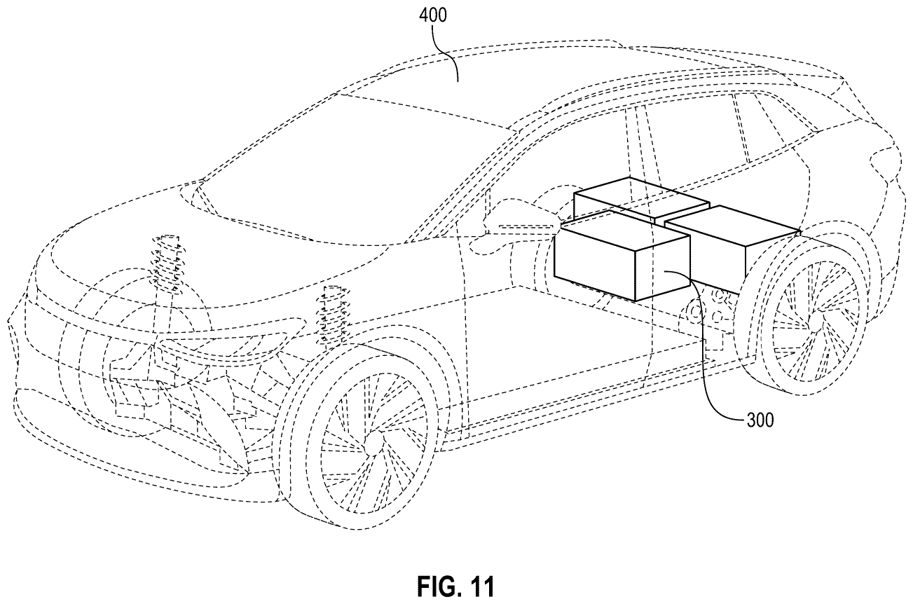

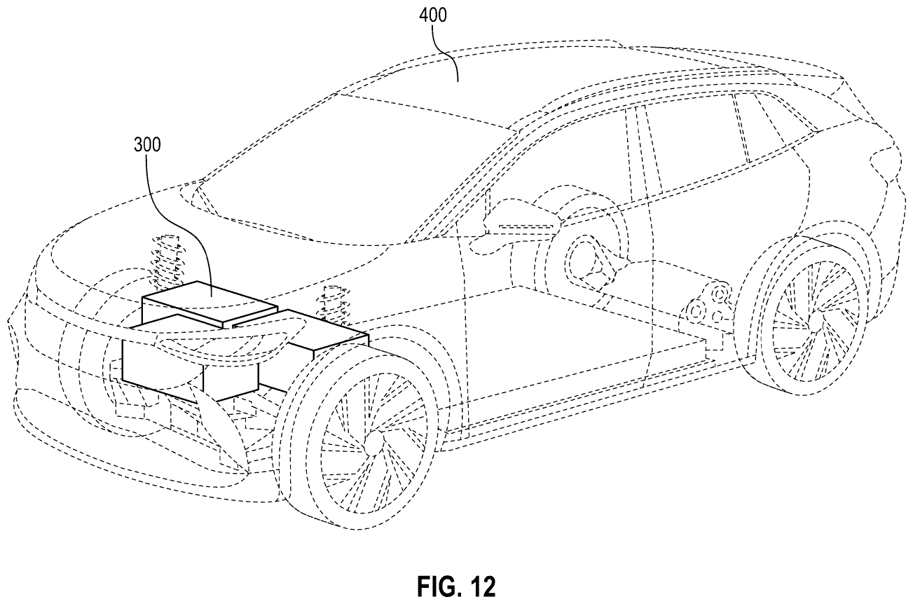

Now referring to FIG. 9, a battery 300 in a square or rectangular configuration is shown, in accordance with one exemplary embodiment of the present invention. Battery 300 incudes battery ports 302 and/or anode(s) and/or the cathode(s) 304, as explained above. Battery 300 can be placed in a variety of configurations or positions in a vehicle 400. FIG. 10 shows battery 300 placed at the center of vehicle 400, in accordance with one exemplary embodiment of the present invention. FIG. 11 shows battery 300 placed at the rear of vehicle 400, in accordance with one exemplary embodiment of the present invention. FIG. 12 shows battery 300 placed at the front of vehicle 400, in accordance with one exemplary embodiment of the present invention.

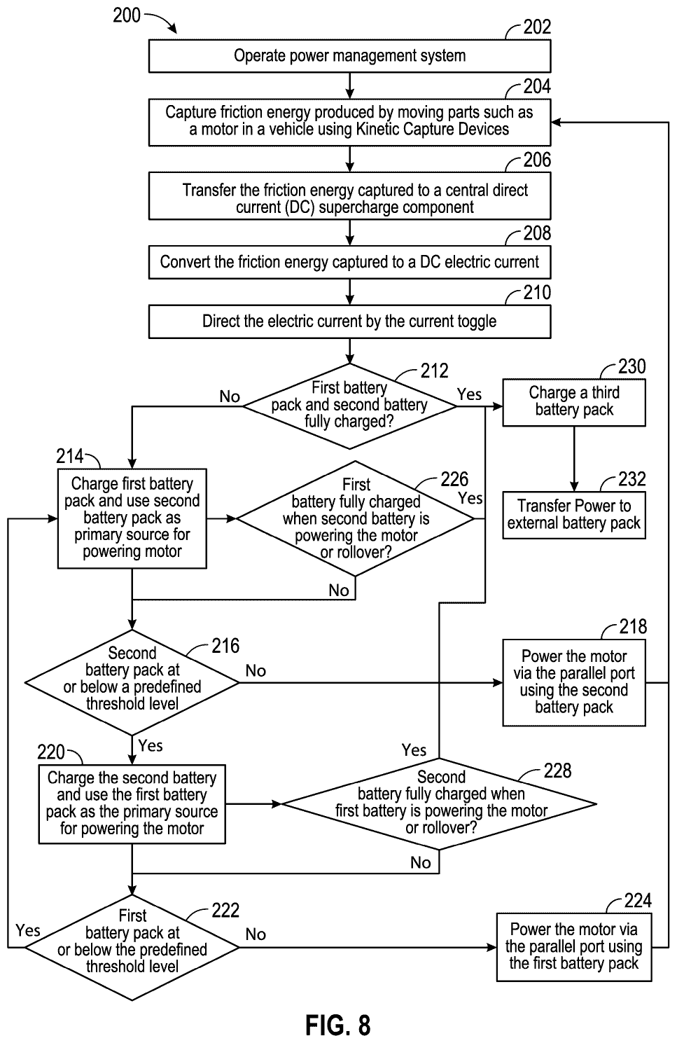

FIG. 8 illustrates method 200 of operating a power management system for a battery-operated vehicle, in accordance with one exemplary embodiment of the present subject matter. The order in which method 200 is described should not be construed as a limitation, and any number of the described method blocks can be combined in any order to implement method 200 or alternate methods. Additionally, individual blocks may be deleted from method 200 without departing from the spirit and scope of the subject matter described herein. Furthermore, method 200 can be implemented in any suitable hardware, software, firmware, or combination thereof. However, for ease of explanation, in the embodiments described below, method 200 may be implemented using the above-described power management system 12.

As specified above, power management system 12 connects to vehicle 14 at axle and/or drive shaft 20. Power management system 12 operates when vehicle 14 is motion, as shown at step 202. Movement of vehicle 14 causes moving parts to produce kinetic friction energy. Kinetic capture devices 22 capture the kinetic friction energy produced by the moving parts, as shown at step 204. At step 206, kinetic capture devices 22 transfer the kinetic friction energy captured to central direct current (DC) supercharge component 24 (CDCSC) 24. At step 208, CDCSC 24 converts the kinetic friction energy to a DC electric current. CDCSC 24 connects to current toggle 28, whereby current toggle 28 directs the DC electric current to one of first battery pack 32, second battery pack 36, and third battery pack 44 (step 210).

At step 212, current toggle 28 checks whether first battery pack 32 and second battery pack 36 are fully charged. Considering that second battery pack 36 is fully charged (or has sufficient charge to power electric motor 42) and first battery pack 32 is depleted (below the predefined threshold level) or requires charging, then current toggle 28 directs the DC electric current to charge first battery pack 32 and uses second battery pack 36 as a primary battery source for operating electric motor 42 (step 214). At step 216, current toggle 28 checks with second power output flow governor 38 if second battery pack 36 is at or below a predefined threshold level charge. If second battery pack 36 has sufficient charge, then current toggle 28 in conjunction with second power output flow governor 38 instructs parallel port 40 to direct power flow f from second battery pack 36 to operate electric motor 42, as shown at step 218. If charge in second battery pack 36 is at or below a predefined threshold level charge (at step 216), then method 200 moves to step 120. At step 120, current toggle 28 directs the DC electric current to charge second battery pack 36 and uses first battery pack 36 as a primary battery source for operating electric motor 42. At step 222, current toggle 28 checks with first power output flow governor 34 if first battery pack 32 is at or below a predefined threshold level charge. If first battery pack 32 has sufficient charge, then current toggle 28 in conjunction with first power output flow governor 32 instructs parallel port 40 to direct power flow f from first battery pack 32 to operate electric motor 42, as shown at step 224. If charge in first battery pack 32 is at or below a predefined threshold level charge (at step 222), then method 200 moves back to step 214.

Upon powering electric motor 42 at steps 218 and 224, electric motor 42 drives drive shaft 20 which in turn operates moving parts in vehicle 12 to produce kinetic friction energy which gets captured by kinetic capture devices 22 at step 204. This creates a constant power supply loop for operating electric motor 42 from the power out of one of first battery pack 32 and second battery pack 36.

At the time of charging first battery pack 32 at step 214, current toggle 28 determines whether first battery pack 32 has fully charged while second battery pack 36 has sufficient charge to power electric motor 42 (step 226). If first battery pack 32 has fully charged while second battery pack 36 has sufficient charge to power electric motor 42, then current toggle 28 directs the DC electric current to charge third battery pack 44 (step 230). If not (step 226), then method 200 moves to step 216.

Similarly, at the time of charging second battery pack 36 at step 220, current toggle 28 determines whether second battery pack 36 has fully charged while first battery pack 32 has sufficient charge to power electric motor 42 (step 228). If second battery pack 36 has fully charged while first battery pack 32 has sufficient charge to power electric motor 42, then current toggle 28 directs the DC electric current to charge third battery pack 44 (step 230). If not (step 228), then method 200 moves to step 222. After charging third battery pack 44 at step 130, the battery power gets transferred to external battery pack 48, as shown at step 232.

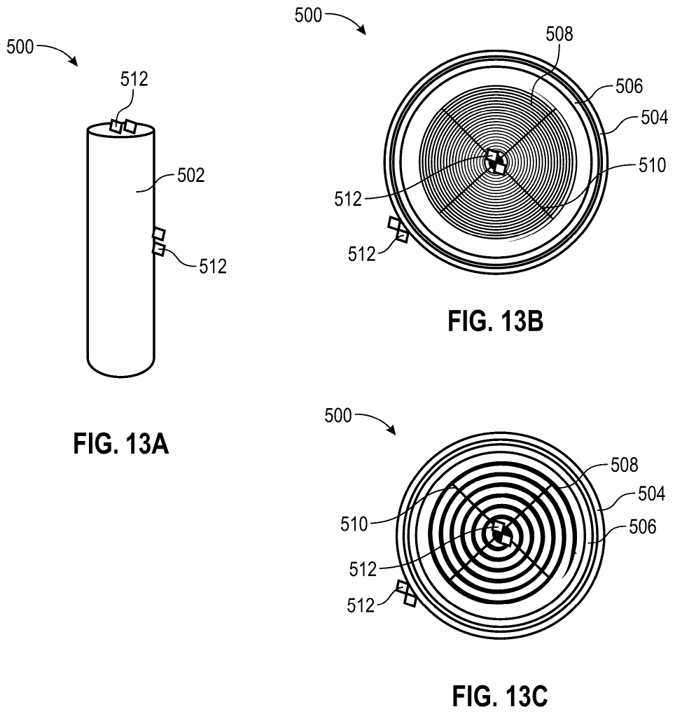

FIGS. 13A and 13B show a perspective view and a top (a first end) view, respectively of a graphene cylinder battery (GCB), or simply battery 500, in accordance with another embodiment of the invention. Battery 500 has a cylindrical body 502, as shown in FIG. 13A. Further, battery 500 has a thermophotovoltaic (TPV) sensor casing 504 that surrounds a battery casing 506. Battery casing 506 includes multiple graphene sheets 508. Graphene sheets 508 are attached with the help of attachment posts 510 to retain them in shape.

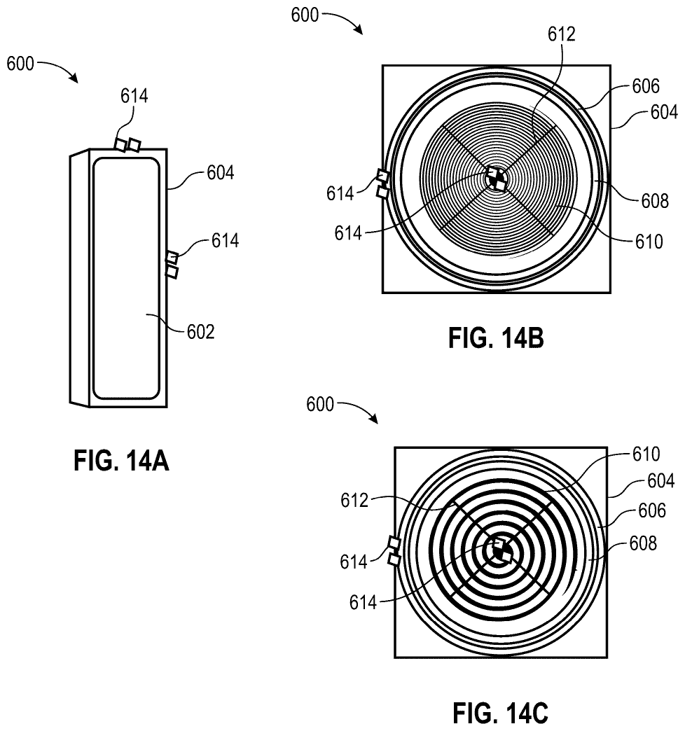

The internal structure layout of graphene sheets 508 includes alternately or independently concentric circles or spheres of independent graphene sheets 508 small to large in scope from the center at the battery anchor post to the outer battery casing 506. Alternatively, graphene sheets 508 include one extended, unbroken, expanding and encircling itself in a pinwheel formation from the center at the battery anchor post to the outer battery casing anchors, filling the battery casing as shown in FIG. 14C (another embodiment). The battery ports 512 maintain the integrity structure of spherical battery casing 506 and provide anchoring for graphene sheets 508. Battery port 512 includes a parallel port or separate ports (one for inflow, and another for outflow). Battery 500 optimizes inflow of recharge to the “secondary battery” position (second battery pack 36), and outflow of power capability for the “primary battery” (first battery pack 32). The super conducting capabilities of graphene sheets 508 and reactive fluid is superior to existing lithium-ion battery packs.

At the outer side, TPV sensor casing 504 includes battery ports 512 that supply power to electric motor 42, as explained above. Battery ports 512 receive an anode(s) and/or cathode(s) that can be positioned on, around, or about battery 500.

FIG. 13C shows another end view shown in FIG. 13B, in which graphene sheets 508 are arranged in a continuous or expanding “pinwheel structure”, in accordance with another embodiment of the present invention.

FIGS. 14A and 14B show a perspective view and a top view, respectively, of a graphene encased cylindrical battery (GECB), or simply battery 600, in accordance with one embodiment of the invention. Battery 600 has a cylindrical body 602 encased in a box (neutral) casing 604, as shown in FIG. 14A. Further, battery 600 has a thermophotovoltaic (TPV) sensor casing 606 that surrounds a battery casing 608. Battery casing 608 includes multiple graphene sheets 610. Graphene sheets 610 are attached with the help of attachment posts 612 to retain them in shape.

The internal structure layout of graphene sheets 610 includes alternately or independently concentric circles or spheres of independent graphene sheets 610 small to large in scope from the center at the battery anchor post to the outer battery casing 608. Alternatively, graphene sheets 610 include one extended, unbroken, expanding and encircling itself in a pinwheel formation from the center at the battery anchor post to the outer battery casing anchors, filling the battery casing as shown in FIG. 14C (another embodiment). The battery ports 614 maintain the integrity structure of spherical battery casing 608 and provide anchoring for graphene sheets 610. Battery port 614 includes a parallel port or separate ports (one for inflow, and another for outflow). Battery 600 optimizes inflow of recharge to the “secondary battery” position (second battery pack 36), and outflow of power capability for the “primary battery” (first battery pack 32). The super conducting capabilities of graphene sheets 610 and reactive fluid is superior to existing lithium-ion battery packs.

At the outer side, TPV sensor casing 606 includes battery ports 614 that supplies power to electric motor 42, as explained above. Battery ports 614 receive an anode(s) and/or cathode(s) that can be positioned on, around, or about battery 600.

FIG. 14C shows another end view in which graphene sheets 610 are arranged in a continuous or expanding “pinwheel structure”, in accordance with another embodiment of the present invention.

Based on the above, a person skilled in the art understands that the presently disclosed power management system uses less energy as it requires no recharging from external sources, and delivers more efficient and constant operational function. This allows the vehicle to have constant, renewable, and uninterrupted power in both operational range and operational time to EVs and similar mechanically powered machinery and industrial systems, without the need for external plug-in recharging needs. The presently disclosed power management system allows for use the entire life span of battery packs and/or electric motor.

Further, under normal operating conditions, the presently disclosed power management system allows the battery-powered electric vehicles to have nearly unlimited range of travel (distance)—without interruption, or need for time consuming stops for “plugging in” for recharging. The presently disclosed power management system comes in-built in new battery-operated vehicles or retro-fits into current electric motor-powered vehicles operating with conventional lithium or other market standard battery sources, removing need for downtime/offline recharging, and extending operational range and life exponentially.

Further, the presently disclosed power management system is adaptable and effective in multiple operational instances, including most vehicle types (land, water, and air-based), as well as military transport and deployment, industrial mechanical operations including resource extraction wellhead drilling, many industrial plant and refinery operations, water well management, municipal infrastructure and transportation, construction and demolition vehicles, extreme condition power generation, and exo-atmospheric scenarios.

As the presently disclosed power management system powers the vehicle upon movement of the moving parts, the power management system operates independently of all reasonable weather conditions, lack of sunlight, water, wind and with proper insulation, even in the vacuum of space.

The presently disclosed power management system provides a long-sought need of energy efficiency, power management platform expansion, and control for most concepts. The presently disclosed power management system provides a power management and on-board recharge flow platform and energy efficiency needs.

The kinetic capture devices provide a unique kinetic energy capture/collection hardware design and makes kinetic energy capture/collection process efficiency and adaptability. With the proposed kinetic capture devices efficiency of energy and transform functions increases considering the vehicular systems related to overall weight and structural dynamics. In addition, the kinetic capture devices provide an ability to integrate/utilize multiple sensors capture components (solar, TPV, wind, compression).

The presently disclosed power management system provides less hardware, less gross weight, and therefore less vehicular drag and less wasted system redundancies.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead be performed by a single component.

Some portions of the above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware, or hardware, and when embodied in software, could be downloaded to reside on and be operated from different platforms used by real-time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. Also, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purposes only and should not be construed in a limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

I claim:

1. A power management system for a battery-operated vehicle, said power management system comprising:
a plurality of kinetic capture devices, wherein said plurality of kinetic capture devices capture kinetic friction energy from movement of moving parts in said battery-operated vehicle;
a central direct current (DC) supercharge component (CDCSC) connecting said plurality of kinetic capture devices, wherein said CDCSC converts the kinetic friction energy to a DC electric current;
a first battery pack and a second battery pack, wherein said first battery pack is distinct from said second battery pack;
a control toggle configured to direct the DC electric current from said CDCSC to said first battery pack and said second battery pack;
a parallel port connecting said first battery pack and said second battery pack, wherein said parallel port draws power from said first battery pack and said second battery pack and delivers to an electric motor for powering said battery-operated vehicle; and
a third battery pack distinct from said first battery pack and said second battery pack, wherein each of said first battery pack, said second battery pack and said third battery pack comprises an anode and/or cathode that: is comprised completely or partially of graphene, or includes a layering or covering of graphene, or utilizes a filtering, flow through, and/or contact point with or chemical reaction chain engaging with graphene;
wherein when said first battery pack is fully recharged, said first battery pack powers said electric motor via said parallel port and said control toggle directs the DC electric current from said CDCSC to said second battery pack for recharging said second battery pack,
wherein when said first battery pack reaches a pre-defined depletion threshold level, said control toggle switches the DC electric current from said CDCSC to said first battery pack for recharging said first battery pack, wherein said second battery pack powers the electric motor via said parallel port, and
wherein said current toggle directs the DC electric charge to said third battery back:
when said first battery pack and said second battery pack are fully recharged, or
when a residual electric charge generated from said kinetic charge devices is not needed to recharge said first battery pack when second battery pack is powering said electric motor, or
when a residual electric charge generated from said kinetic charge devices is not needed to recharge said second battery pack when first battery pack is powering said electric motor.

2. The power management system of claim 1, wherein said plurality of kinetic capture devices capture the kinetic friction energy from one of an axle, a drive shaft, braking, sensors, axle friction recharge, wheel rotation friction recharge, brake pad friction, exterior vehicle/mechanism friction capture, wind/water, and solar surface on said battery-operated vehicle.

3. The power management system of claim 1, wherein said plurality of kinetic capture devices deliver a single or multiple distinct electric charges to said CDCSC via a flow transfer cable.

4. The power management system of claim 1, wherein said third battery pack powers said electric motor when said first battery pack and said second battery pack are at or below said pre-defined depletion threshold level.

5. The power management system of claim 1, wherein said third battery pack stores and transfers energy to an external battery pack via a transfer port.

6. The power management system of claim 1, further comprises Thermophotovoltaics (TPV) heat sensors, wherein said TPV heat sensors surround said first battery pack and said second battery pack, wherein said TPV heat sensors capture the heat produced from said first battery pack and said second battery pack and create a distinct DC electric current, and wherein TPV heat sensors feed the DC electric current said CDCSC and act as an additional sourcing of electric current generated in said power management system.

7. The power management system of claim 1, wherein said control toggle maintains and records the depletion point or predefined threshold levels of charge to switch recharging of said first battery pack and said second battery pack.

8. The power management system of claim 1, wherein said first battery pack comprises a first power output flow governor, wherein said first power output flow governor maintains a power output ceiling of said first battery pack for providing operating power to said electric motor, and wherein said first power output flow governor communicates with said current toggle for switching recharging of said first battery pack and said second battery pack.

9. The power management system of claim 1, wherein said second battery pack comprises a second power output flow governor, wherein said second power output flow governor maintains a power output ceiling of said second battery pack for providing operating power to said electric motor, and wherein said second power output flow governor communicates with said current toggle for switching recharging of said first battery pack and said second battery pack.

10. The power management system of claim 1, wherein said electric motor operates causing distinct kinetic friction energy through the movement of moving parts in said battery-operated vehicle, wherein said plurality of kinetic capture devices capture the kinetic friction energy and create creating a loop for recharging one of said first battery pack and said second battery pack for powering said electric motor.

11. The power management system of claim 1, wherein said GSB comprises a cylindrical battery shell with concentric circles of thin graphene sheet material attached to internal anchoring posts holding the graphene material in place, and wherein said anode and/or cathode being included in combination or distinctly from said GSB.

12. The power management system of claim 11, wherein said graphene sphere battery comprises a thermophotovoltaic (TPV) sensor casing surrounding a battery casing, wherein said battery casing comprises graphene sheets attached using attachment posts to retain them in shape, and wherein said TPV sensor casing comprises battery ports for supplying power to said electric motor.

13. A method of operating a power management system for powering a battery-operated vehicle, the method comprising steps of:
capturing kinetic friction energy from movement of moving parts in said battery-operated vehicle;
converting the kinetic friction energy captured to a DC electric current;
directing the DC electric current for recharging a first battery pack and a second battery pack;
drawing power from said first battery pack and said second battery pack for powering an electric motor of said battery-operated vehicle;
switching the DC electric current for recharging said first battery pack and said second battery pack, said switching comprising:
directing the DC electric current to said second battery pack for recharging said second battery pack when said first battery pack is fully recharged and utilizing said first battery pack for powering said electric motor; and
directing the DC electric current to said first battery pack for recharging said first battery pack when said first battery pack reaches a pre-defined depletion threshold level and utilizing said second battery pack for powering said electric motor; and
providing a third battery pack distinct from said first battery pack and said second battery pack, each of said first battery pack, said second battery pack and said third battery pack comprises an anode and/or cathode having completely or partially of graphene, or including a layering or covering of graphene, or utilizing a filtering, flow through, and/or contact point with or chemical reaction chain engaging with graphene, said method further comprising:
switching the DC electric current for recharging said third battery back:
when said first battery pack and said second battery pack are fully recharged, or
when a residual electric charge generated from said kinetic charge devices is not needed to recharge said first battery pack when second battery pack is powering said electric motor, or
when a residual electric charge generated from said kinetic charge devices is not needed to recharge said second battery pack when first battery pack is powering said electric motor.

14. The method of claim 13, further comprising:
causing distinct kinetic friction energy through the movement of moving parts in said battery-operated vehicle with the operation of said electric motor;
capturing the distinct kinetic friction energy for creating a loop for recharging one of said first battery pack and said second battery pack for powering said electric motor.

15. The method of claim 13, further comprising storing and transferring energy stored in said third battery pack to an external battery pack.

16. The method of claim 13, further comprising powering said electric motor using said third battery pack when said first battery pack and said second battery pack are at or below said pre-defined depletion threshold level.

17. The method of claim 13, further comprising:
providing Thermophotovoltaics (TPV) heat sensors surrounding said first battery pack and said second battery pack;
capturing the heat produced from said first battery pack and said second battery pack for creating a distinct DC electric current; and
feeding the DC electric current as an additional sourcing of electric current generated in said power management system for recharging said first battery pack and said second battery pack.

18. The method of claim 13, further comprising providing a cylindrical battery shell having concentric circles of thin graphene sheet material attached to internal anchoring posts holding the graphene material in place for each of said first battery pack, said second battery pack and said third battery pack.

19. The method of claim 13, further comprising providing a cylindrical battery shell a having a pinwheel patterned design containing one or more extended graphene sheet(s) encircling itself in a pinwheel pattern of a thin graphene sheet material attached to internal anchoring posts holding the graphene material in place for each of said first battery pack, said second battery pack and said third battery pack.

20. The method of claim 13, further comprising providing said GSB in a square, rectangular, cylindrical, or encased cylindrical battery shell having the graphene material in place for each of said first battery pack, said second battery pack and said third battery pack, said anode and/or cathode being included in combination or distinctly from said GSB.
